(19) United States
(12) Patent Application Publication
(10) Pub. No.: US 2005/0071248 A1
(43) Pub. Date: Mar. 31, 2005

(54) Information input device and order-receiving system

(75) Inventors: Reiko Yamauchi, Tokyo (JP); Shinji Murata, Tokyo (JP); Toshiya Sato, Tokyo (JP); Tsuyoshi Narumiya, Tokyo (JP); Yuichi Marikawa, Tokyo (JP); Hiroyuki Uemura, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc., Tokyo (JP)

(21) Appl. No.: 10/946,854

(22) Filed: Sep. 22, 2004

(30) Foreign Application Priority Data
Sep. 30, 2003 (JP) JP2003-342644

(51) Int. Cl. G06F 17/60

(52) U.S. Cl. 705/26

(57) ABSTRACT

The information input device comprises: a design template having template information which can be changed by at least input information; and information input section for inputting template information; and an information processing section for processing the input information that is input by the information input section in accordance with the template information.

### TECHNICAL FIELD

The present invention relates to an information input device and order-receiving system used for ordering postcards and the like for example, using a network.

### BACKGROUND

In the past, in creating postcards and the like, a worker used image processing software to create data with text, images and the like combined, and the operation of combining the image to compose the postcards depended on the competence and skill of the worker. Thus in the case of image formation for New Year cards which require large volume production, quality of the postcards was not constant since the operation depended to a great extent on the competence and skill of the worker, and the operation characteristics were poor because photo image input, text input and illustration input were successively performed.

Because of this, a card creation system has been provided in which it is possible to automatically perform even complex card compositions (example Japanese Patent Publication Laid-Open to Public Inspection No. 11-112784) and design templates are provided for each postcard category (wedding, birth, and moving), and when the card design is created using the design template, large volume operations can be performed without error.

It is to be noted that in this case because the information needed is different depending on the design template selected, if the information is input using the same input format, there will sometimes be excess or shortage of data. Also in view of protecting personal information, the user usually does not wish to input excess information, and also this is a waste of time.

Furthermore, if there is a shortage of data, the data must be requested repeatedly. The designer involved in the design creation process thus finds operation difficult when there is excess data, while in the case where there is shortage of data, the information must be obtained and this leads to operational inefficiency.

Also, the service of allowing input of zodiac signs, special days or the like on the design template in English may be provided, but the user may find it difficult to input the information in English, and thus it is easier for input to be done in Japanese. In addition, in the case where the designer received the information in Japanese, the designer must look up the words in the dictionary in order translate to English, and even if the designer knows the words, the information must be provided in English in order to avoid spelling errors.

### SUMMARY

The present invention was conceived in view of these points and an object thereof is to provide an information input device and order receiving system in which it is possible for input of information corresponding to the design template to be performed simply and with certainty, and without any excess or shortage of information.

In order to solve the problems and achieve the object, this invention is configured as follows.

The information input device of this invention comprises: a design template having pre-stored template information which can be changed by at least input information; an information inputting section for inputting template information; and an information processing section for processing the input information input by the information input section in accordance with the template information.

The order-receiving system of this invention comprises: a user terminal which is connected to the network and is for inputting design determining information, uploading images for use in a design and ordering the design; an order manager terminal which is connected to the network, and is for receiving the design orders, placing orders for the design creation work based on the design order and managing the received orders via an order server, and a worker terminal which is connected to the network and is for creating designs based on the orders placed for the design creation work, wherein a design template is selected which has pre-stored template information which can be changed by at least input information from the user terminal, and the information to be displayed at the design template is input by the information inputting section, and the input information is processed in accordance with the information template and the design is ordered.

The information processing section of the present invention also performs the process of converting the input language to another language. Furthermore, the information processing section may also perform the process of converting the input information to related information.

The present invention has the following effects as a result of having the above-described configuration.

The design template has pre-stored template information, which can be changed by at least input information, and inputting of information in accordance with the design template can be done simply and with certainty, without any excess or shortage of information by processing the input information that is input by the input section in accordance with the template information.

In the case, for example, of use of the invention in ordering postcards and the like using a network, a design template is selected which has pre-stored template information which can be changed by at least input information, and the information to be displayed on the template is input by an information input section, and the input information is processed in accordance with the template information, and thus inputting of information can be done simply and with certainty, without any excess or shortage of information.

In addition, by performing the process of converting the input language to another language, if for example the user inputs information in Japanese, conversion to English can be performed without any errors and the operation characteristics are thereby improved.

Furthermore, by performing the process of converting the input information to related information, for example when the user inputs date of birth, conversion to zodiac sign, age or the animal sign of the Japanese zodiac without error is possible, and thus the operation characteristics are improved.

### BRIEF DESCRIPTION OF THE DRAWINGS

FIG. 1 shows an information input device and an order receiving system.

FIG. 2 is a flowchart of design ordering which is performed using the user terminal.

FIG. 3 shows the design selection screen in the case where the New Year category has been selected.

FIG. 4 shows the selected design template.

FIG. 5 shows the order information input screen.

FIG. 6(a) shows inputting of zodiac sign and date of birth.

FIG. 6(b) shows inputting of zodiac sign and date of birth.

FIG. 7 shows the image upload screen.

FIG. 8 shows the design content confirmation screen.

FIG. 9 shows the credit card information input screen.

FIG. 10 shows the postcard type/quantity input screen.

FIG. 11 shows the print order charge confirmation screen.

FIG. 12 shows the receiving/payment method selection screen.

FIG. 13 shows the shop selection screen.

FIG. 14 shows the address/credit card information input screen.

FIG. 15 shows the print order final confirmation screen.

FIG. 16 shows the design order complete screen.

### PREFERRED EMBODIMENTS OF THE INVENTION

The following describes an embodiment of the information input device and order receiving system of this invention, but this invention is not to be limited by this embodiment. Also this embodiment of the invention is the most preferred embodiment of the invention, and the terminology is not limited to that of this embodiment.

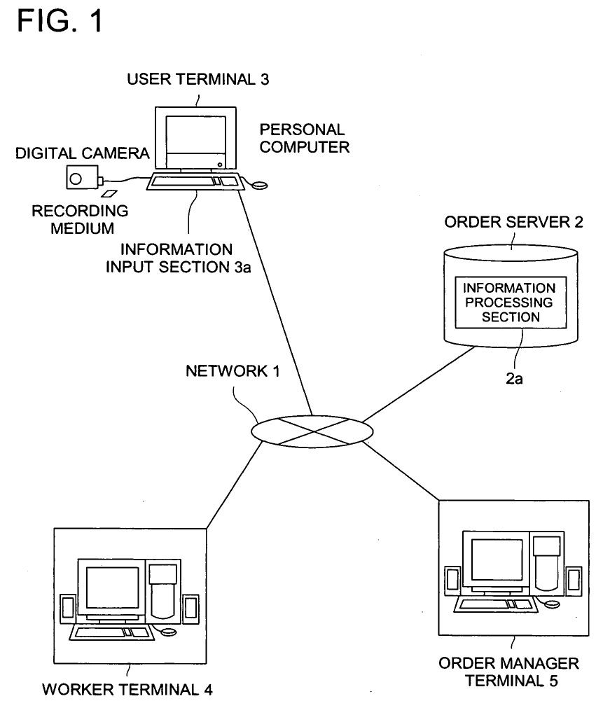

FIG. 1 shows the information input device and order receiving system. In FIG. 1 the order server 2, the user terminal 3, the worker terminal 4, and the order manger terminal 5 are connected to the network 1 and each of these may communicate via the network 1.

The network 1 is a network in which a computer system, terminals and data communication devices are connected to each other. The network may be connected by wire such as by dedicated lines, public lines, or may be connected wirelessly by communication satellite or the like. The network may also be connected by a combination of both. That it to say, examples of the network include the internet and the like.

The order server 2 receives design orders, places orders for the design creation work based on the design order and does order management via network 1, and also provides the network image services of listing the images for use in the design, storing images, managing customer information and the like.

The user terminal 3 may be any electronic device terminal that is capable of sending and receiving text and image information such as a personal computer, a personal digital assistant (PDA) or a mobile phone. In the case of a personal computer or personal digital assistant (PDA), the user terminal may be connected to a digital camera, and a recording medium on which an image has been recorded may be set in the digital camera so that an image can be uploaded. The image may also be uploaded from a scanner or the like. For a mobile phone that is equipped with a digital camera, the image may be obtained by taking pictures with the digital camera, and for a mobile telephone that is not equipped with a digital camera the image may be obtained by being sent from another electronic device.

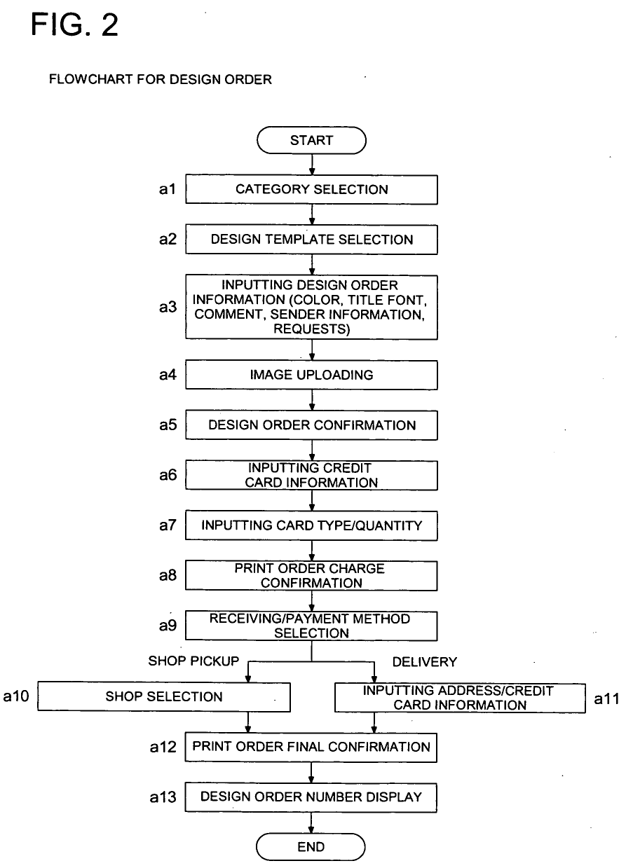

At the user terminal 3, design determining information is input, the images for use in the design are uploaded, and the design is ordered. Design ordering is shown in FIG. 2 to FIG. 15. The order manager terminal 5 receives design orders, places orders for the design creation work based on the design order and manages the placed orders via the order server 2, and is capable of displaying the images for use in the design.

At the worker terminal 4, design creation work is done on an image correction screen based on the design creation work order. The design work refers to image processing and image correction such as removing unnecessary background from an image or correcting red eye, but is not limited thereto.

In this embodiment a design template having pre-stored template information which can be changed at least by input information from the user terminal 3 is selected. Design templates are prepared in advance at the order server 2 for each category (wedding, birthday, moving and the like). Information to be displayed at the design template is input by an information inputting section 3a such as a keyboard of the user terminal 3, and the information processing section 2a of the order server 2 processes the input information in accordance with the template information and the design ordering is thereby performed. The information processing section 2a performs the process of converting the input language into another language. For example, if the user inputs information in Japanese, conversion to English can be performed without any errors and the operation characteristics are thereby improved. Also, the process of converting the input information to related information may be performed. For example, the user may input date of birth and this is converted to zodiac sign, age or animal sign of the Japanese zodiac without error, and thus the operation characteristics are improved.

In this manner in the case where the invention is used for ordering postcards or the like using a network, a design template is selected which has pre-stored template information which can be changed by at least input information from the user terminal 3, and the information to be displayed at the design template is input by the information inputting section 3a, and the input information is processed in accordance with the template information and thus information input in accordance with the design template can be done simply and with certainty, and design ordering can be done without any excess or shortage of information.

The information processing section 2a need not be located at the order server 2 and may instead be located at the user terminal 3 or the worker terminal 4. In this case, the user terminal 3 and the worker terminal 4 are connected by LAN, or else the data may be handled by media.

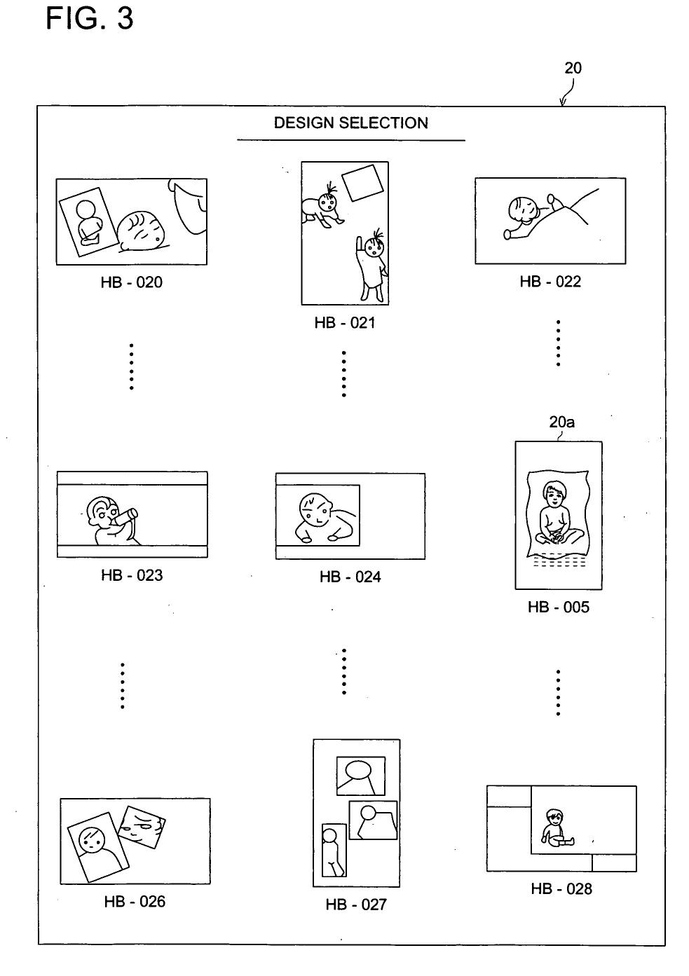

A flow of the design ordering performed using the user terminal 3 is shown in FIG. 2, and screens from the user terminal 3 at which this design ordering is performed are shown in FIG. 3 to FIG. 16.

The order of the steps in FIG. 2, which shows the flow of design ordering may be changed such that image uploading or receiving/payment method selection may be performed first. Also, print order may or may not be performed.

[Step a1]

First, when the design is ordered, the category is selected from among New Year, wedding, birthday, moving and the like. FIG. 3 shows the design selection screen 20 at which the New Year category has been chosen. In this manner, a plurality of design templates 20a are prepared in advance for each category such as New Year, wedding, birth, moving and the like.

[Step a2]

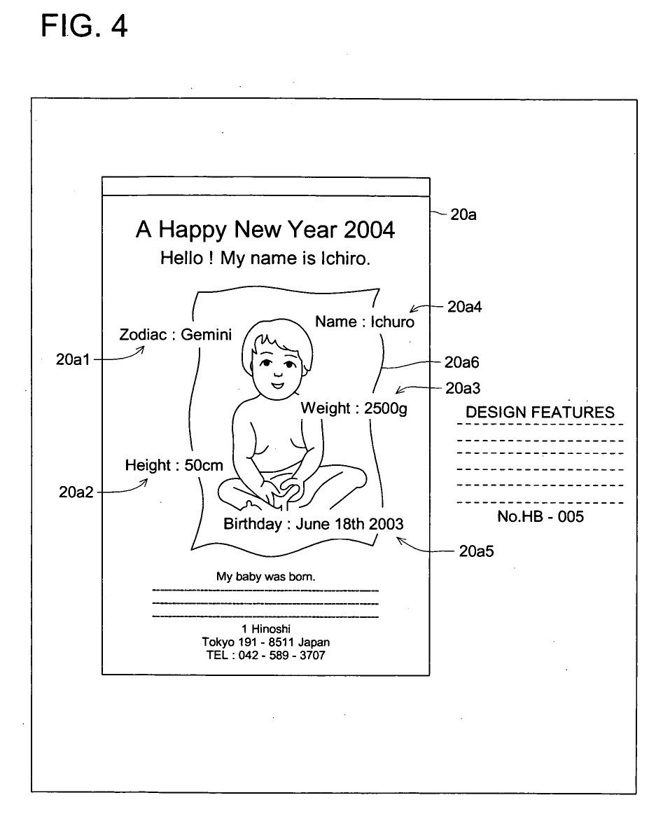

There is a plurality of design templates displayed at the design selection screen 20 shown in FIG. 3 in which the New Year category was selected, and a desired design template is selected from this plurality of design-templates. The selected design template 20a is shown in FIG. 4, and the design template 20a includes the template information 20a1˜20a5 and the image 20a6 which can be changed by input information. Template information 20a1 is the zodiac sign; template information 20a2 is the baby's height; template information 20a3 is the baby's weight; template information 20a4 is the baby's name (in roman letters); template information 20a5 is the baby's birthday, all of which are in English.

[Step a3]

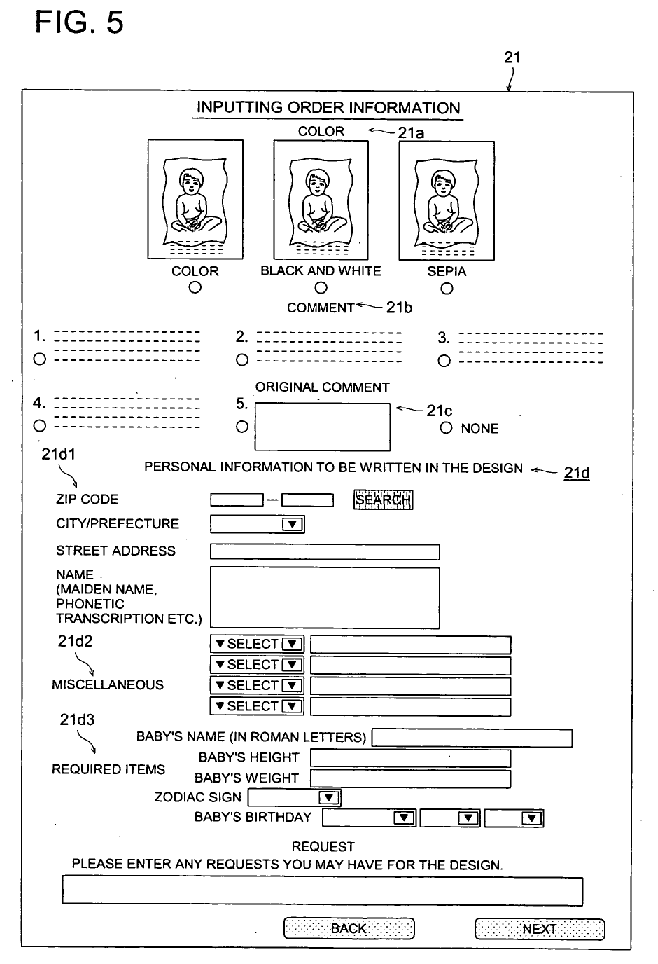

The design order information to be input in the selected design template is input at the order information input screen 21 in FIG. 5. The design order information comprises color 21a, title font 21b, original comment 21c, and personal information to be written in the design 21d. The personal information to be written in the design 21d comprises sender information 21d1, miscellaneous information 21d2, and required items 21d3. The required items 21d3 include baby's name (in roman letters), baby's height, baby's weight, zodiac sign, and baby's birthday, all of which are input in Japanese.

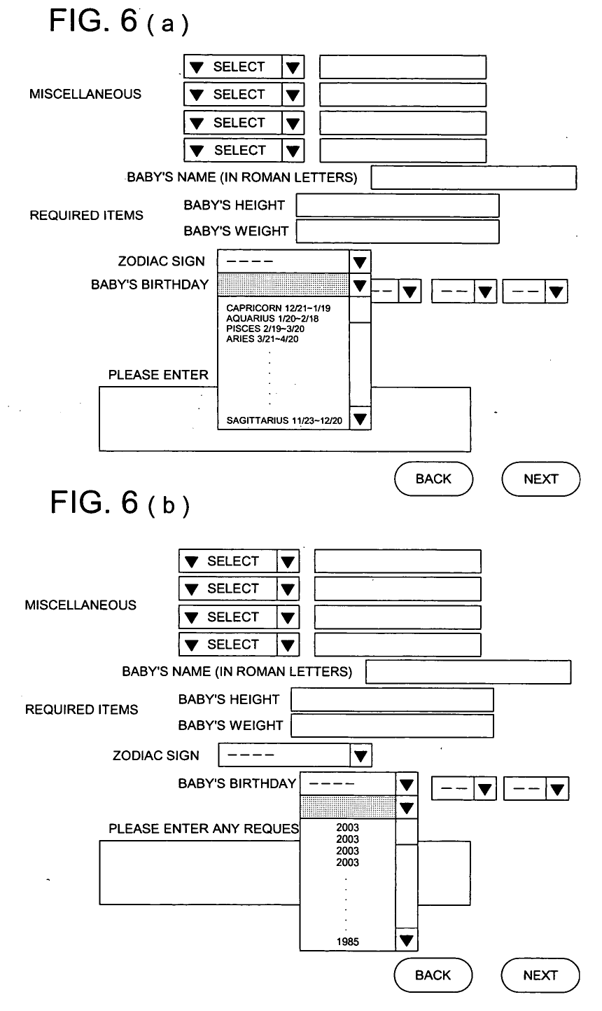

Input of the zodiac sign is done as shown in FIG. 6(a) by clicking zodiac and when the list of the zodiac signs are displayed, and when the date of birth is selected, the applicable zodiac sign is input. Furthermore, inputting of the baby's birthday is done by clicking and displaying date of birth as shown in FIG. 6(b), and selecting and inputting the applicable year, month and day of birth.

The required items 21d3 of the baby's name (in roman letters), baby's height, baby's weight, zodiac sign, and baby's birthday which were input in Japanese are converted to English at the design side of the design template.

[Step a4]

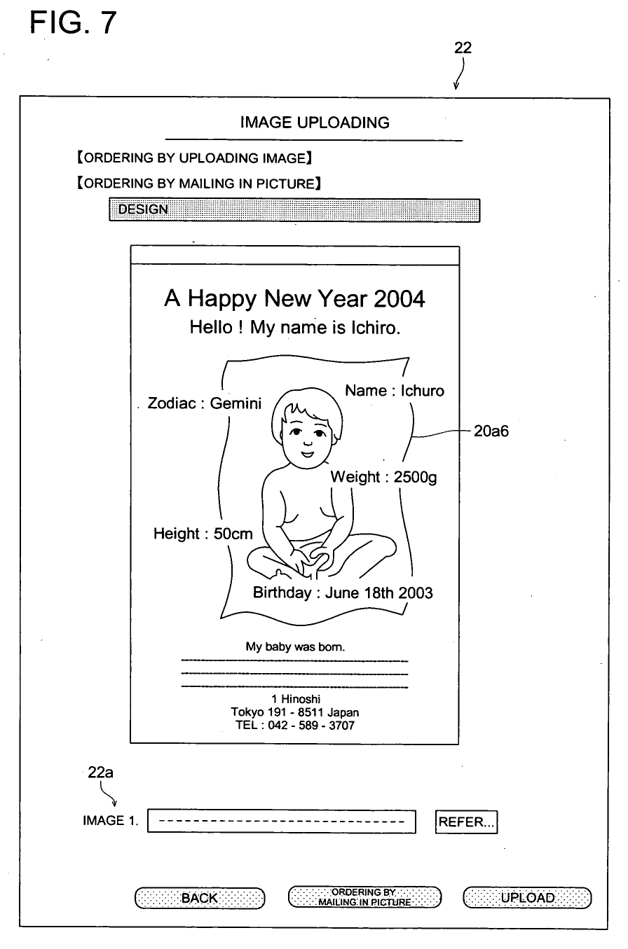

In the image upload screen 22 in FIG. 7, the image 22a to be input in the image 20a6 of selected design template is uploaded. The uploading of this image 22a is not performed using a prescribed file format, and in the case where an image is not uploaded, the order may be made by mailing in a picture.

[Step a5]

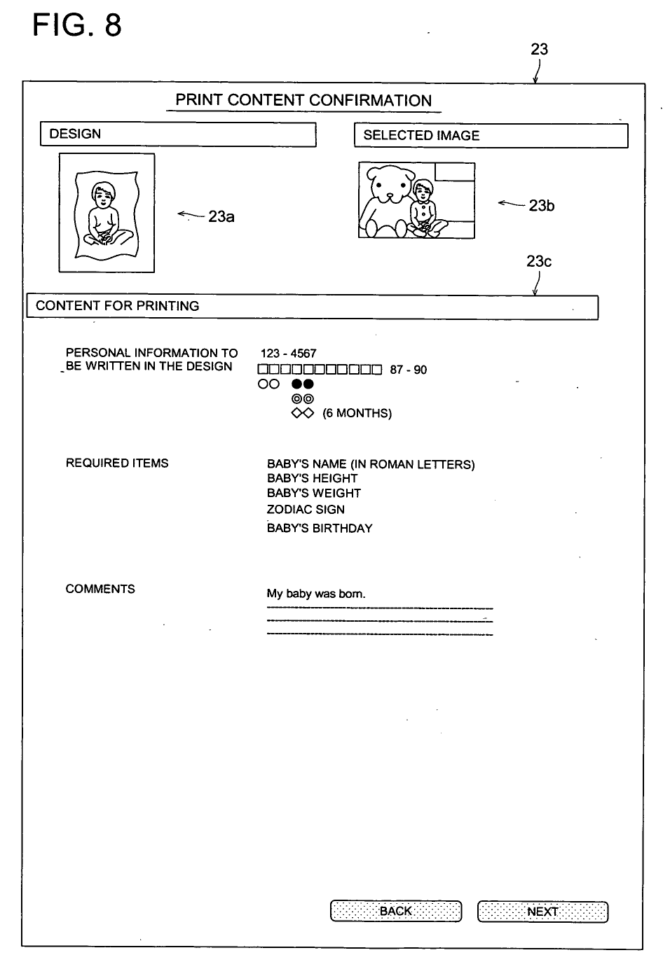

In the design content confirmation screen 23 of FIG. 8, confirmation of the design order is carried out by displaying the design 23a, the selected image 23b, and the content for printing 23c. At this stage, both the input information and the converted information can be checked. The configuration may also be such that only the input information or only the converted information may be confirmed.

[Step a6]

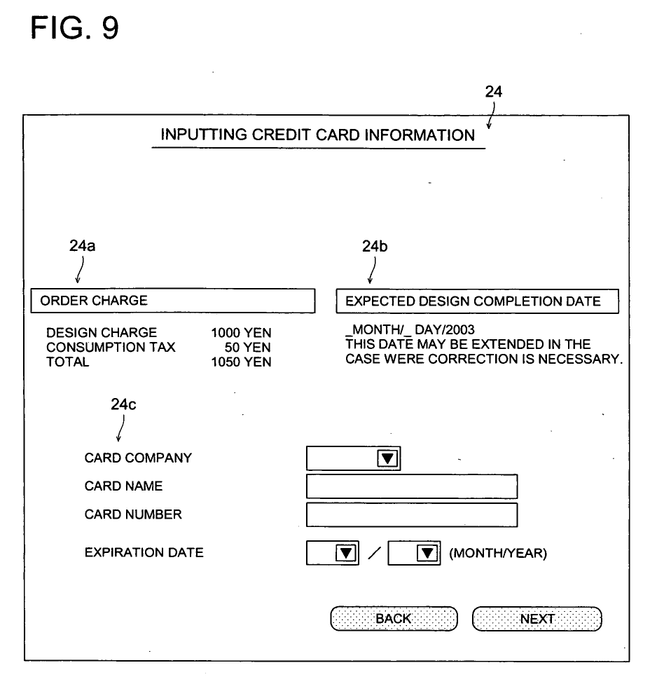

In the credit card information input screen 24 of FIG. 9, the design charge 24a and expected date of completion 24b are checked by being displayed and the credit card information 24c is input. The method of payment of the design charge is not limited to credit card and may be payment at the shop or by bank transfer.

[Step a7]

When printing is to be done, the following step is performed.

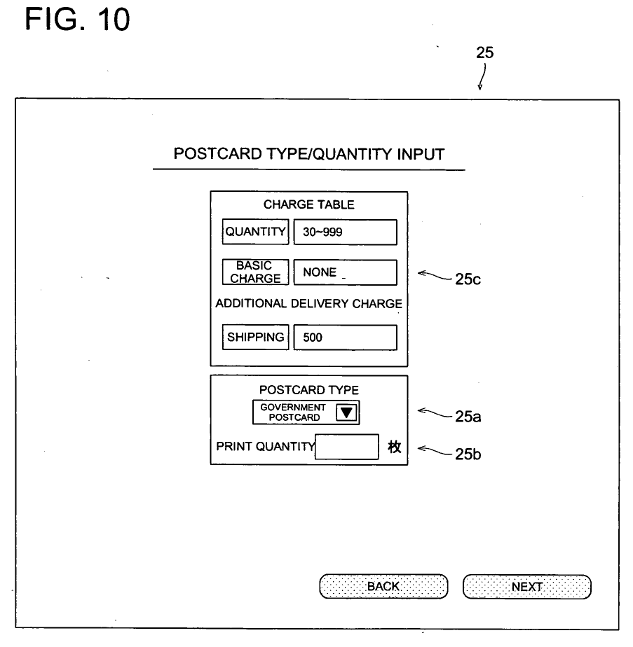

At the postcard type/quantity input screen 25 in FIG. 10, the card type 25a and card quantity 25b are input, and the charge amount 25c is displayed as a result of the card type and card quantity being input.

[Step a8]

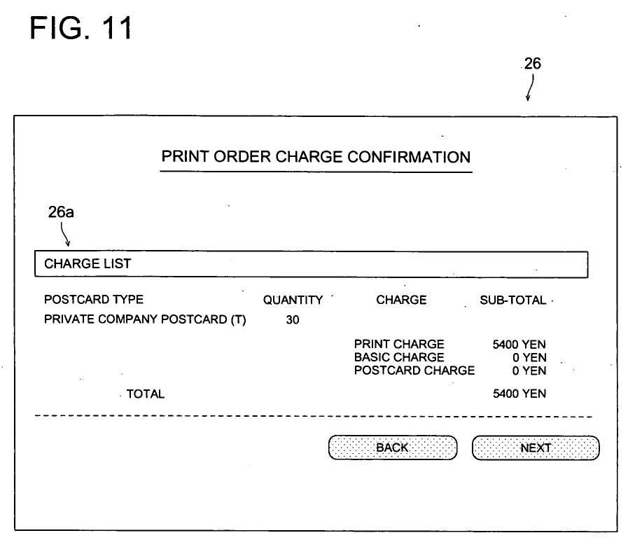

At the print order charge confirmation screen 26 in FIG. 11, the print charge list 26a is displayed, and the print order charge is confirmed.

[Step a9]

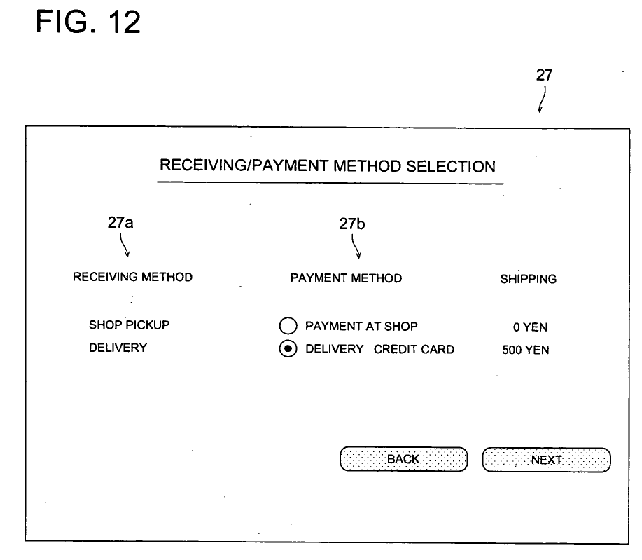

At the receiving/payment method selection screen 27 in FIG. 12, the receiving method 27a and the payment method 27b are selected. The receiving methods 27a include shop pickup and delivery, and the payment methods 27b include payment at the shop or by credit card and the like.

[Step a10]

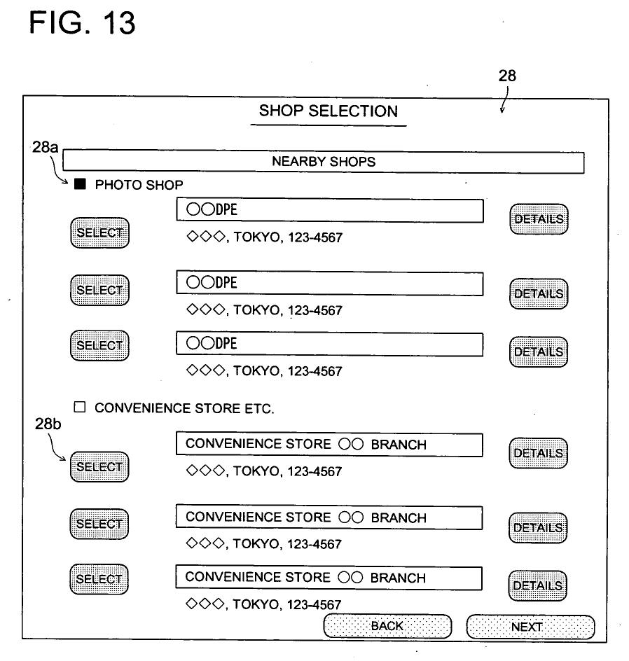

If shop pickup is selected as the receiving method 27a, a nearby shop offering the service is selected from photo shop 28a and convenience store 28b at the shop selection screen in FIG. 13.

[Step a11]

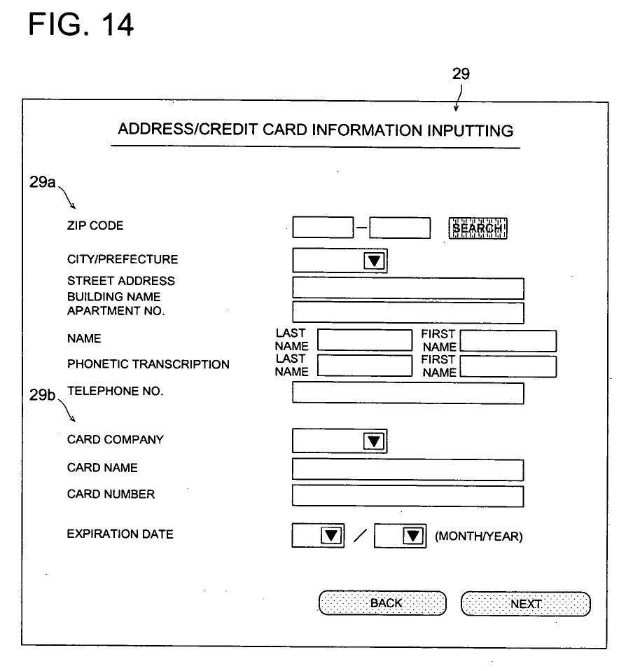

If delivery is selected as the receiving method 27a, the address 29a and the credit card information 29b are input in the address/credit card information input screen 29 in FIG. 14.

[Step a12]

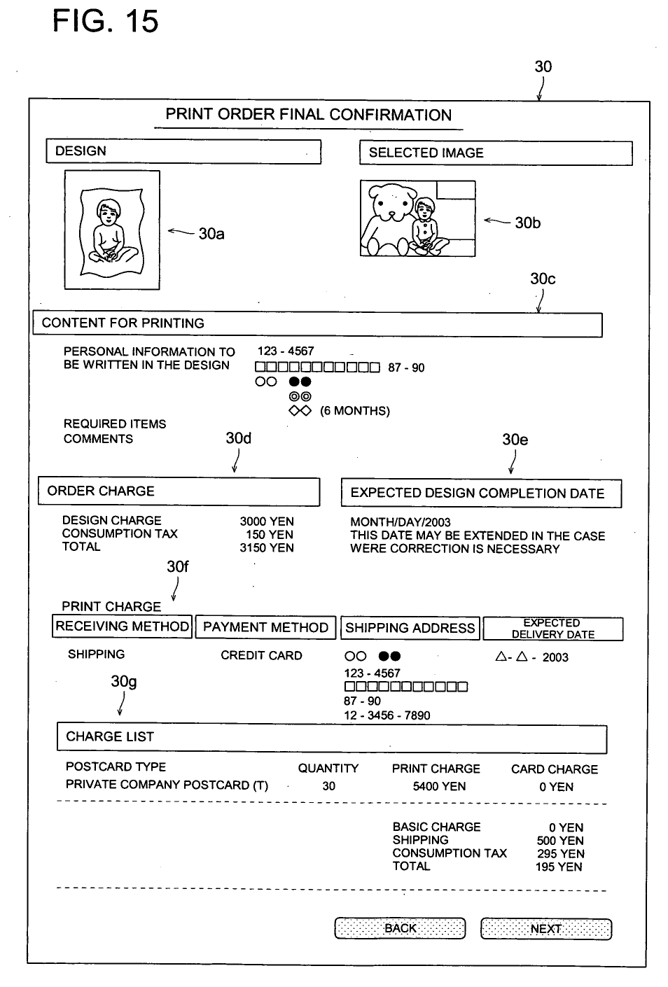

After shop selection or the address/credit card information is input, the design 30a, the selected image 30b, the text content 30c, the design charge 30d, the expected design completion date 30e, the print charge 30f (receiving method, payment method, address, expected delivery date) and charge list 30g are displayed at the print order final confirmation screen 30 in FIG. 15.

[Step a13]

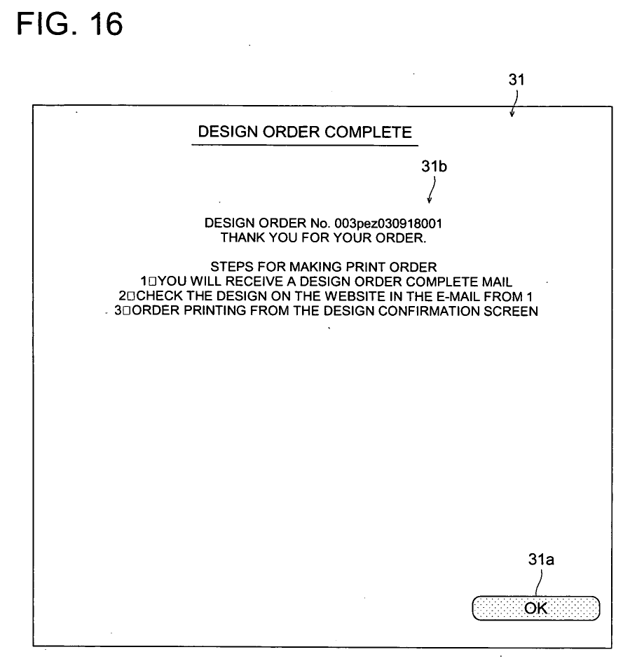

In the design order complete screen 31 in FIG. 16, the order number 31b is displayed, when the OK button 31 is clicked, and the design order is complete.

This invention can be used for creating postcard designs for example with a design template, and large volume operations can be performed without error, and thus used for ordering and the like of postcards using a network.

1. An information input device comprising:
a design template having template information;
an information input section to input the information corresponding to the template information displayed on the design template; and
an information processing section to process the information inputted by the information input section according-to the kind of template information, and to update the design template.

2. The information input device of claim 1, wherein the information processing section to converts the inputted information into the related information based on the inputted information.

3. The information input device of claim 1, wherein the information processing section to converts the input language to another language, when the inputted information is language information.

4. The information input device of claim 1, wherein the information processing section to converts into the image information-corresponding to the birth date information, when the inputted information is birth date information.

5. An order receiving system comprising:
a user terminal comprising;
an information input section to input the information corresponding to template information displayed on a design template,
an image data uploading section to upload an image data for use in a design via network, and ordering the design,
an order manager terminal comprising;
a image data receiving section to receive the design order via an order server connected to the network,
an order section to order the design creation work based on the design order,
a managing section to manage the received order,
a worker terminal to create design based on the ordered design, connected to the network,
wherein at least one of the user terminal, the order manager terminal,.the order server, and the worker terminal having an information processing section to process the information inputted by the information input section according to the kind of template information.

6. The order receiving system of claim 5, wherein the information processing section to converts the inputted information into the related information based on the inputted information.

7. The order receiving system of claim 5, wherein the information processing section to converts the input language to another language, when the inputted information is language information.

8. The order receiving system of claim 5, wherein the information processing section to converts into the image information corresponding to the birth date information, when the inputted information is birth date information.
